(19) United States
(12) Patent Application Publication
(10) Pub. No.: US 2019/0236535 A1
(43) Pub. Date: Aug. 1, 2019

(54) COLD CHAIN ON-THE-DOCK REDISTRIBUTION CONTROL MANAGER

(71) Applicant: CARRIER CORPORATION, Palm Beach Gardens, FL (US)

(72) Inventors: Ciara Poolman, Syracuse, NY (US); Robert A. Chopko, Baldwinsville, NY (US); Marc Beasley, Beverly, MA (US); John Cronin, Bonita Springs, FL (US); Michael Christopher Huffines, Burlington, VT (US)

(21) Appl. No.: 16/311,315

(22) PCT Filed: Jun. 16, 2017
(86) PCT No.: PCT/US2017/037910

§ 371 Date: Dec. 19, 2018

Related U.S. Application Data
(60) Provisional application No. 62/352,409, filed on Jun. 20, 2016.

(51) Int. Cl. G06Q 10/08

(52) U.S. Cl. CPC G06Q 10/0832; G06Q 10/087

(57) ABSTRACT

A system for organizing perishable goods including: a storage device (80) to store perishable good requirements (82), loading dock parameters (86), and perishable good parameters (84) associated with the perishable goods; and a loading dock management system (90) coupled to the storage device. The loading dock management system including: a perishable good risk module (92) to determine a perishable good risk level for each perishable good in response to the perishable good parameters and the perishable good requirements; and a loading dock organizational module (94) to determine a loading dock notification in response to the perishable good risk level and the loading dock parameters.

### BACKGROUND OF THE DISCLOSURE

The embodiments disclosed herein generally relate to cold chain distribution systems, and more specifically to an apparatus and a method for organizing perishable goods.

Typically, cold chain distribution systems are used to transport and distribute perishable goods and environmentally sensitive goods (herein referred to as perishable goods) that may be susceptible to temperature, humidity, and other environmental factors. Perishable goods may include but are not limited to fruits, vegetables, grains, beans, nuts, eggs, dairy, seed, flowers, meat, poultry, fish, ice, and pharmaceuticals. Advantageously, cold chain distribution systems allow perishable goods to be effectively transported and distributed without damage or other undesirable effects.

Refrigerated trucks and trailers are commonly used to transport perishable goods in a cold chain distribution system. A transport refrigeration system is mounted to the truck or to the trailer in operative association with a cargo space defined within the truck or trailer for maintaining a controlled temperature environment within the cargo space.

Conventionally, transport refrigeration systems used in connection with refrigerated trucks and refrigerated trailers include a transport refrigeration unit having a refrigerant compressor, a condenser with one or more associated condenser fans, an expansion device, and an evaporator with one or more associated evaporator fans, which are connected via appropriate refrigerant lines in a closed refrigerant flow circuit. Air or an air/gas mixture is drawn from the interior volume of the cargo space by means of the evaporator fan(s) associated with the evaporator, passed through the airside of the evaporator in heat exchange relationship with refrigerant whereby the refrigerant absorbs heat from the air, thereby cooling the air. The cooled air is then supplied back to the cargo space.

The loading docks of distribution centers and stores are often chaotic complex places, which makes it easy for perishable goods to get misplaced or mishandled. If perishable goods are left on an unrefrigerated loading dock for too long, degradation of the perishable goods may result. Different perishable goods may have different preservation requirements and only leads to the difficulty in orchestrating the complex task of organizing a loading dock. Improved systems, particularly improved tracking and organizational systems would provide benefits to the industry.

### BRIEF DESCRIPTION OF THE DISCLOSURE

According to one embodiment, a system for organizing perishable goods is provided. The system including: a storage device to store perishable good requirements, loading dock parameters, and perishable good parameters associated with the perishable goods; and a loading dock management system coupled to the storage device. The loading dock management system including: a perishable good risk module to determine a perishable good risk level for each perishable good in response to the perishable good parameters and the perishable good requirements; and a loading dock organizational module to determine a loading dock notification in response to the perishable good risk level and the loading dock parameters.

In addition to one or more of the features described above, or as an alternative, further embodiments of the system may include that the loading dock management system is configured to transmit to a user device at least one of the perishable good risk level and the loading dock notification.

In addition to one or more of the features described above, or as an alternative, further embodiments of the system may include a user device configured to scan an identification tag of the perishable goods.

In addition to one or more of the features described above, or as an alternative, further embodiments of the system may include a user device is configured to transmit to the storage device the loading dock parameter in response to the loading dock notification.

In addition to one or more of the features described above, or as an alternative, further embodiments of the system may include a user device configured to activate an alarm when at least one of the perishable good risk level and the loading dock notification is received from the loading dock management system.

In addition to one or more of the features described above, or as an alternative, further embodiments of the system may include at least one sensor configured to monitor the perishable good parameters and transmit the perishable good parameters to the storage device.

According to another embodiment, a method of organizing perishable goods is provided. The method including: storing, using a storage device, perishable good requirements, loading dock parameters, and perishable good parameters associated with the perishable goods; analyzing, using a loading dock management system, the perishable good requirements, the loading dock parameters, and the perishable good parameters. The loading dock management system coupled to the storage device. The loading dock management system including: a perishable good risk module to determine a perishable good risk level for each perishable good in response to the perishable good parameters and the perishable good requirements; and a loading dock organizational module to determine a loading dock notification in response to the perishable good risk level and the loading dock parameters.

In addition to one or more of the features described above, or as an alternative, further embodiments of the method may include transmitting, using the loading dock management system, to a user device at least one of the perishable good risk level and the loading dock notification.

In addition to one or more of the features described above, or as an alternative, further embodiments of the method may include scanning, using a user device, an identification tag of the perishable goods.

In addition to one or more of the features described above, or as an alternative, further embodiments of the method may include transmitting, using a user device, to the storage device the loading dock parameter in response to the loading dock notification.

In addition to one or more of the features described above, or as an alternative, further embodiments of the method may include activating, using a user device, an alarm when at least one of the perishable good risk level and the loading dock notification is received from the loading dock management system.

In addition to one or more of the features described above, or as an alternative, further embodiments of the method may include: monitoring, using at least one sensor, the perishable good parameters; and transmitting the perishable good parameters to the storage device.

According to another embodiment a computer program product tangibly embodied on a computer readable medium is provided. The computer program product including instructions that, when executed by a processor, cause the processor to perform operations. The operations including: storing, using a storage device, perishable good requirements, loading dock parameters, and perishable good parameters associated with the perishable goods; and analyzing, using a loading dock management system, perishable good requirements, loading dock parameters, and perishable good parameters. The loading dock management system coupled to the storage device. The loading dock management system including: a perishable good risk module to determine a perishable good risk level for each perishable good in response to the perishable good parameters and the perishable good requirements; and a loading dock organizational module to determine a loading dock notification in response to the perishable good risk level and the loading dock parameters.

In addition to one or more of the features described above, or as an alternative, further embodiments of the computer program may include that the operations further include transmitting, using the loading dock management system, to a user device at least one of the perishable good risk level and the loading dock notification.

In addition to one or more of the features described above, or as an alternative, further embodiments of the computer program may include that the operations further include scanning, using a user device, an identification tag of the perishable goods.

In addition to one or more of the features described above, or as an alternative, further embodiments of the computer program may include that the operations further include transmitting, using a user device, to the storage device the loading dock parameter in response to the loading dock notification.

In addition to one or more of the features described above, or as an alternative, further embodiments of the computer program may include that the operations further include activating, using a user device, an alarm when at least one of the perishable good risk level and the loading dock notification is received from the loading dock management system.

In addition to one or more of the features described above, or as an alternative, further embodiments of the computer program may include that the operations further include: monitoring, using at least one sensor, the perishable good parameters; and transmitting the perishable good parameters to the storage device.

Technical effects of embodiments of the present disclosure include tracking various parameters of perishable goods and using the parameters as well as perishable good requirements to better organize loading docks.

The foregoing features and elements may be combined in various combinations without exclusivity, unless expressly indicated otherwise. These features and elements as well as the operation thereof will become more apparent in light of the following description and the accompanying drawings. It should be understood, however, that the following description and drawings are intended to be illustrative and explanatory in nature and non-limiting.

### BRIEF DESCRIPTION OF THE DRAWINGS

The subject matter which is regarded as the disclosure is particularly pointed out and distinctly claimed in the claims at the conclusion of the specification. The foregoing and other features and advantages of the disclosure are apparent from the following detailed description taken in conjunction with the accompanying drawings in which:

FIG. 1 illustrates a schematic view of a system for organizing perishable goods, according to an embodiment of the present disclosure;

FIG. 2 illustrates a schematic view a cold chain distribution system that may incorporate embodiments of the present disclosure; and

FIG. 3 is a flow diagram illustrating a method of organizing perishable goods, according to an embodiment of the present disclosure.

### DETAILED DESCRIPTION OF THE DISCLOSURE

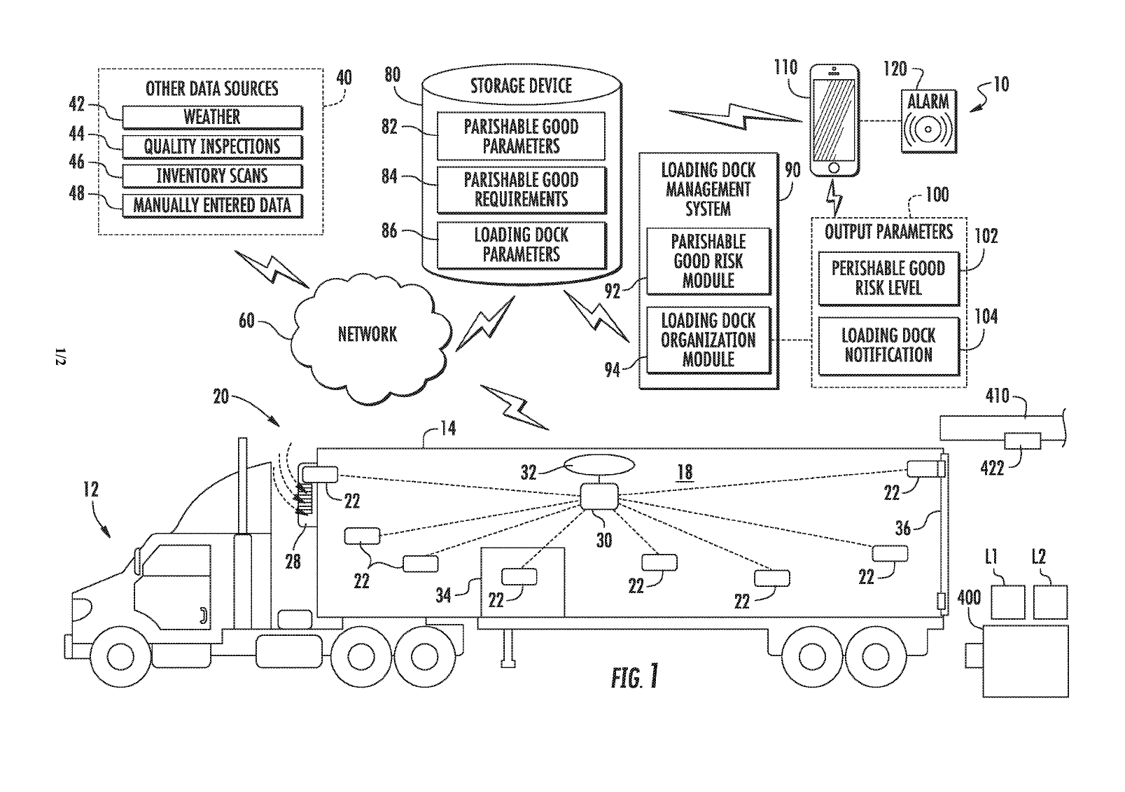

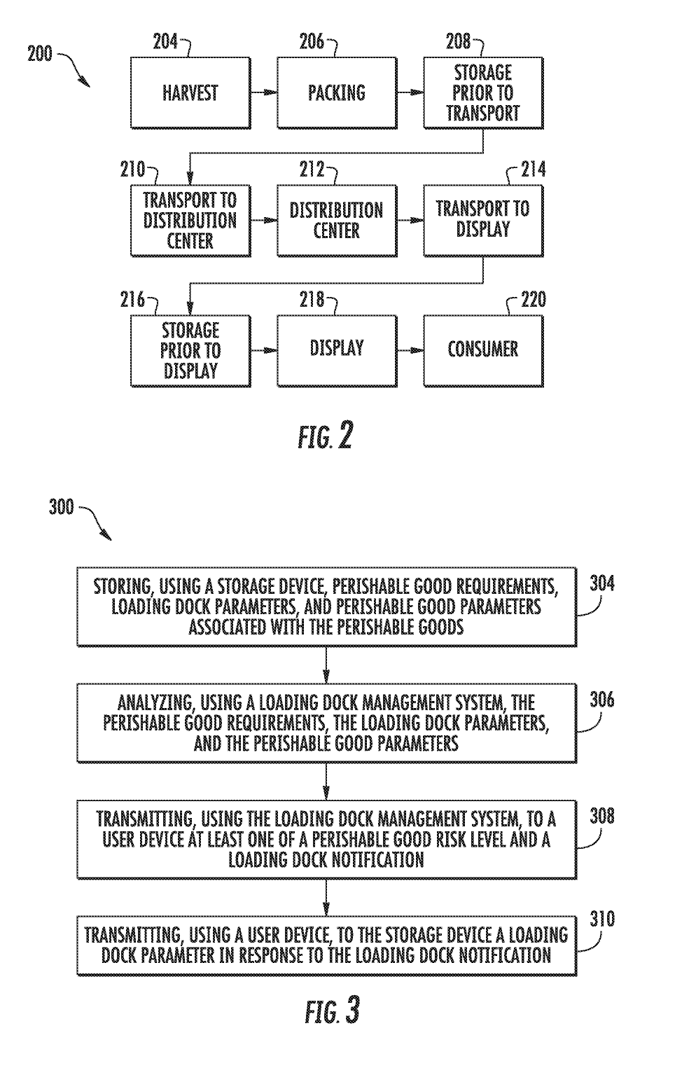

Referring now to the drawings, FIG. 1 illustrates a schematic view of a system 10 for organizing perishable goods, according to an embodiment of the present disclosure. FIG. 2 illustrates a schematic view a cold chain distribution system 200 that may incorporate embodiments of the present disclosure. Typically, transport refrigeration systems 20 are used to transport and distribute perishable goods and environmentally sensitive goods (herein referred to as perishable goods 34). In the illustrated embodiment, a transport refrigeration system 20 includes an environmentally controlled container 14, a transport refrigeration unit 28 and perishable goods 34. The container 14 may be pulled by a tractor 12. It is understood that embodiments described herein may be applied to shipping containers that are shipped by rail, sea, or any other suitable container, without use of a tractor 12. The container 14 may define an interior compartment 18.

In the illustrated embodiment, the transport refrigeration unit 28 is associated with a container 14 to provide desired environmental parameters, such as, for example temperature, pressure, humidity, carbon dioxide, ethylene, ozone, light exposure, vibration exposure, and other conditions to the interior compartment 18. In further embodiments, the transport refrigeration unit 28 is a refrigeration system capable of providing a desired temperature and humidity range. The perishable goods 34 may include but are not limited to fruits, vegetables, grains, beans, nuts, eggs, dairy, seed, flowers, meat, poultry, fish, ice, blood, pharmaceuticals, or any other suitable cargo requiring cold chain transport.

In the illustrated embodiment, the transport refrigeration system 20 includes sensors 22. The sensors 22 may be utilized to monitor perishable good parameters 82 of the perishable goods 34. The perishable good parameters 82 monitored by the sensors 22 may include but are not limited to temperature, pressure, humidity, carbon dioxide, ethylene, ozone, light exposure, vibrations, and other conditions in the interior compartment 18. Accordingly, suitable sensors 22 are utilized to monitor the perishable good parameters 82. Advantageously, sensors 22 may be selected for certain applications depending on the type of perishable goods 34 to be monitored and the corresponding environmental sensitivities. In an embodiment, temperatures are monitored. As seen in FIG. 1, the sensors 22 may be placed directly on the perishable goods 34.

The sensors 22 may be placed in a variety of locations including but not limited to on the transport refrigeration unit 28, on a door 36 of the container 14, on a loading dock 400, and throughout the interior compartment 18. The sensors 22 may be placed directly within the transport refrigeration unit 28 to monitor the performance of the transport refrigeration unit 28. As seen, the sensors 22 may also be placed on the door 36 of the container 14 to monitor the position of the door 36. Whether the door 36 is open or closed affects both the temperature of the container 14 and the perishable goods 34. For instance, in hot weather, an open door 36 will allow cooled air to escape from the container 14, causing the temperature of the interior compartment 18 to rise, thus affecting the temperature of the perishable goods 34. Additionally, a global positioning system (GPS) location may also be detected by the sensors 22. The GPS location may help in providing time-based location information for the perishable goods 34 that will help in tracking the travel route and other perishable good parameters 82 along that route. For instance, the GPS location may also help in providing information from other data sources 40 regarding weather 42 experienced by the container 14 along the travel route. The local weather 42 affects the temperature of the container 14 and thus may affect the temperature of the perishable goods 34.

As illustrated in FIG. 1, the transport refrigeration system 20 may further include, a controller 30 configured to log a plurality of readings from the sensors 22, known as the perishable good parameters 82, at a selected sampling rate. The controller 30 may be enclosed within the transport refrigeration unit 28 or separate from the transport refrigeration unit 28 as illustrated. The perishable good parameters 82 may further be augmented with time, location stamps or other relevant information. The controller 30 may also include a processor (not shown) and an associated memory (not shown). The processor may be but is not limited to a single-processor or multi-processor system of any of a wide array of possible architectures, including field programmable gate array (FPGA), central processing unit (CPU), application specific integrated circuits (ASIC), digital signal processor (DSP) or graphics processing unit (GPU) hardware arranged homogenously or heterogeneously. The memory may be but is not limited to a random access memory (RAM), read only memory (ROM), or other electronic, optical, magnetic or any other computer readable medium.

In an illustrated embodiment, the transport refrigeration system 20 may include a communication module 32 in operative communication with the controller 30 and in wireless operative communication with a network 60. The communication module 32 is configured to transmit the perishable good parameters 82 to the network 60 via wireless communication. The wireless communication may be, but is not limited to, radio, microwave, cellular, satellite, or another wireless communication method. The network 60 may be but is not limited to satellite networks, cellular networks, cloud computing network, wide area network, or another type of wireless network. The communication module 32 may include a short range interface, wherein the short range interface includes at least one of: a wired interface, an optical interface, and a short range wireless interface.

Perishable good parameters 82 may also be provided by other data sources 40, as illustrated in FIG. 1. These other data sources 40 may be collected at any point throughout the cold chain distribution system 200, which as illustrated in FIG. 2 may include harvest 204, packing 206, storage prior to transport 208, transport to distribution center 210, distribution center 212, transport to display 214, storage prior to display 216, display 218 and consumer 220. Additionally, perishable good parameters 82 may also be collected at a loading dock 400. These stages are provided for illustrative purposes and a distribution chain may include fewer stages or additional stages, such as, for example a cleaning stage, a processing stage, and additional transportation stages. The other data sources 40 may include, but are not limited to, weather 42, quality inspections 44, inventory scans 46, and manually entered data 48. The weather 42, as discussed above, has an effect on the operation of the transport refrigeration unit 28 by influencing the temperature of the container 14 during transport (e.g., 210 and 214) but the weather 42 also has other influences on the transport refrigeration unit 28. For instance, the weather 42 prior to and at harvest 204 may have an impact on the quality of the perishable goods 34, which may affect freshness. The weather 42 on the loading dock 400 may also be a perishable good parameter 82. Moreover, quality inspections 44, similar to the weather 42, may reveal data of the perishable goods 34 that affects freshness. For instance, a particular batch of strawberries may have been subjected to rainfall at harvest time, making them prone to spoilage. Quality inspections 44 may be done by a machine or a human being. Quality inspections 44 performed by a machine may be accomplished using a variety of techniques including but not limited to optical, odor, soundwave, infrared, or physical probe.

Further, inventory scans 46 may also reveal perishable good parameters 82 about the perishable goods 34 and may help in tracking the perishable goods 34. For instance, the inventory scan 46 may reveal the time, day, truck the perishable goods arrived on, which may help identify the farm if previously unknown. While the system 10 includes sensors 22 to aid in automation, often times the need for manual data entry is unavoidable. The manually entered data 48 may be input via a variety of devices including but not limited to a cellular phone, tablet, laptop, smartwatch, a desktop computer or any other similar data input device known to one of skill in the art.

Perishable good parameters 82 collected throughout each stage of the cold chain distribution system 200 may include environment conditions experienced by the perishable goods 34 such as, for example, temperature, pressure, humidity, carbon dioxide, ethylene, ozone, vibrations, light exposure, weather, time and location. For instance, strawberries may have experienced an excessive shock or were kept at 34° F. during transport. Perishable good parameters 82 may further include attributes of the perishable goods 34 such as, for example, temperature, weight, size, sugar content, maturity, grade, ripeness, labeling, and packaging. For instance, strawberries may be packaged in 1 pound clamshells, be a certain weight or grade, be organic, and have certain packaging or labels on the clamshells. Perishable good parameters 82 may also include information regarding the operation of the environmental control unit 28, as discussed above. The perishable good parameters 82 may further be augmented with time, location stamps or other relevant information.

In the illustrated embodiment, the system 10 further includes a storage device 80 to store the perishable good parameters 82 associated with the perishable goods 34 of a distribution chain. At least one of the perishable good parameters 82 may be received from a transport refrigeration system. The storage device 80 is connected to the communication module 32 through the network 60. The storage device 80 may be but is not limited to a random access memory (RAM), read only memory (ROM), or other electronic, optical, magnetic or any other computer readable medium.

As shown, the storage device 80 also stores perishable good requirement 84 such as, for example government regulations, customer requirements, industry standards, and internal standards. The perishable good requirements 84 may outline the required environmental conditions that should be maintained for specific perishable good 34 and may also outline contamination risks that some perishable goods might have with other perishable goods. For instance, the perishable good requirements 84 may include that bananas need to be kept at a temperature of about sixty-five degrees Fahrenheit and kept away from tomatoes, which release ethylene and promote ripening in bananas.

The storage device 80 may also store loading dock parameters 86. Loading dock parameters 86 may include details regarding a loading dock 400 such as for example, loading dock size, loading dock locations (L1, L2), loading dock locations occupied status, loading dock overhead coverage 410, loading dock weather conditions, loading dock employee availability or other similar details. It is understood that embodiments described herein may be applied past the physical loading dock and into storage space within the distribution center 212 or the store storage prior to display 216.

In the illustrated embodiment, the system 10 further includes a loading dock management system 90. The loading dock management system 90 is connected to the communication module 32 through the network 60. The loading dock management system 90 is also coupled to the storage device 80. As shown, the loading dock management system 90 includes a perishable good risk module 92 and a loading dock organization module 94. The loading dock management system 90 may also include a processor (not shown) and an associated memory (not shown). The associated memory may be the storage device 80. The processor may be but is not limited to a single-processor or multi-processor system of any of a wide array of possible architectures, including field programmable gate array (FPGA), central processing unit (CPU), application specific integrated circuits (ASIC), digital signal processor (DSP) or graphics processing unit (GPU) hardware arranged homogenously or heterogeneously. The memory may be but is not limited to a random access memory (RAM), read only memory (ROM), or other electronic, optical, magnetic or any other computer readable medium. The perishable good risk module 92 and the loading dock organization module 94 may be implemented in software as applications executed by the processor of the loading dock management system 90.

A worker on a loading dock 400 may use a user device 110 to scan an identification (ID) tag of the perishable good 34. The user device 110 may be a device such as, for example, a cellular phone, tablet, laptop, smartwatch, desktop computer, hand held scanner or any similar device. The ID tag may be a Universal Product Code (UPC) bar code, Quick Response (QR) code, or another identification methodology known to one of skill in the art. Further, the perishable goods may also be identified automatically as soon as they arrive at the loading dock 400 by a radio-frequency identification (RFID) tag on the perishable good 34 and an associated dock sensor 422. The dock sensor 422 may also be able to sense loading dock parameters 86, such as, for example, weather, temperature, humidity, loading dock location occupancy and the loading dock organization scheme.

Once the perishable goods 34 arrive at the loading dock 400 and are identified, the perishable good risk module 92 determines a perishable good risk level 102 for each perishable good 34. The perishable good risk module 92 determines a perishable good risk level 102 for each the perishable good 34 in response to the perishable good parameters 82 and the perishable good requirements 84. The perishable good risk level 102 may be sent to a user device 110, which displays to a worker the perishable good risk level 102. From the perishable good risk 82, the worker may determine whether additional quality inspections 44 of the perishable good 34 are required. The loading dock organization module 94 determines a loading dock notification 104 in response to the perishable risk level 102 and the loading dock parameters 86. The loading dock notification 104 may be sent to a user device 110 to display to a worker the loading dock notification 104. The loading dock notification 104 may inform the worker that whether the perishable good 34 should be placed in a first location L1 or a second location L2. The loading dock notification 104 may also inform the worker that a perishable good 34 should be moved from a first location L1 to a second location L2. For instance, if the loading dock 400 does not have proper overhead coverage 410, the loading dock management system 90 may then check the perishable good parameters 82 to see if the perishable goods 34 are packaged to stay on a loading dock 400 with no overhead coverage 410 move it accordingly.

The locations L1, L2 are all saved as loading dock parameters 86 in the storage device 86. The dock sensor 422 may also send loading dock parameters 86 to the storage device 80. For instance, the dock sensor 422 may indicate indicating which locations L1, L2 are occupied and which locations L1, L2 are empty. The loading dock parameters 86 may also include information regarding the workers at the loading dock, so that the loading dock organization module 94 may take into account which workers are currently working at the loading dock 400 on a given day and divvy out the loading dock notifications 104 accordingly. For instance, a worker may receive a loading dock notification 104 directly to a smart watch (user device 110) indicating to move a particular perishable good to the second location L2 on the loading dock 400. Further, the dock sensor 22 may be able to inform the loading dock management system 90 when the perishable good 34 has been automatically or the worker may indicate that the loading dock notification 104 has been completed on their user device 110, which will send a loading dock parameter 86 back to the storage device 80 indicating the new location L1, L2. Advantageously, utilizing knowledge of an organization layout of loading dock, environmental conditions at the loading dock, and the perishable good risk level a loading dock management system could place perishable goods in the optimum location on a loading dock. Further advantageously, a loading dock management system could also divert the transport refrigeration system to another loading dock if there are not free location or if conditions are not correct at the loading dock for the particular perishable goods.

The output parameters 100, including the perishable good risk level 102 and the loading dock notifications 104, may be accessible via the user device 110 and/or sent directly to the user device 110. The output parameters 100 may be configured as at least one of a map displaying time-based locations of the perishable goods 34 along with the output parameters 100 at the time-based locations, a data table of output parameters 100, a text write-up (not shown), or any other method of displaying output parameters 100 known to one of skill in the art. Further, the output parameters 100 may be sent to the user device 110 as a visual and/or audible alarm 120.

Referring now also to FIG. 3, which shows a flow diagram illustrating a method 300 of organizing perishable goods 34, according to an embodiment of the present disclosure. At block 304, the storage device 80 stores perishable good requirements 82, loading dock parameters 84, and perishable good parameters 85 associated with the perishable goods 34. At block 306, the loading dock management system 90 analyzes the perishable good requirements 82, the loading dock parameters 84, and the perishable good parameters 85. At block 308, the loading dock management system 90 may transmit to the user device 110 at least one of the perishable good risk level 102 and the loading dock notification 104. At block 310, the user device 110 may transmit to the storage device 80 a loading dock parameter 86 in response to the loading dock notification 104.

The method 300 may also include the user device 110 scanning an identification tag of the perishable goods 34. The method 300 may further include the user device 110 activating an alarm 120 when at least one of the perishable good risk level 102 and the loading dock notification 104 is received from the loading dock management system 90. The method 300 may yet further include utilizing at least one sensor 22 to monitor the perishable good parameters 82 and transmitting the perishable good parameters 82 to the storage device 80.

While the above description has described the flow process of FIG. 3 in a particular order, it should be appreciated that unless otherwise specifically required in the attached claims that the ordering of the steps may be varied.

While the disclosure has been described in detail in connection with only a limited number of embodiments, it should be readily understood that the disclosure is not limited to such disclosed embodiments. Rather, the disclosure can be modified to incorporate any number of variations, alterations, substitutions or equivalent arrangements not heretofore described, but which are commensurate with the scope of the disclosure. Additionally, while various embodiments of the disclosure have been described, it is to be understood that aspects of the disclosure may include only some of the described embodiments. Accordingly, the disclosure is not to be seen as limited by the foregoing description, but is only limited by the scope of the appended claims.

What is claimed is:

1. A system for organizing perishable goods, the system comprising:
a storage device to store perishable good requirements, loading dock parameters, and perishable good parameters associated with the perishable goods;
a loading dock management system coupled to the storage device, the loading dock management system including:
a perishable good risk module to determine a perishable good risk level for each perishable good in response to the perishable good parameters and the perishable good requirements; and
a loading dock organizational module to determine a loading dock notification in response to the perishable good risk level and the loading dock parameters.

2. The system of claim 1, wherein:
the loading dock management system is configured to transmit to a user device at least one of the perishable good risk level and the loading dock notification.

3. The system of claim 1, further comprising:
a user device configured to scan an identification tag of the perishable goods.

4. The system of claim 1, further comprising:
a user device is configured to transmit to the storage device the loading dock parameter in response to the loading dock notification.

5. The system of claim 1, further comprising:
a user device configured to activate an alarm when at least one of the perishable good risk level and the loading dock notification is received from the loading dock management system.

6. The system of claim 1, further comprising:
at least one sensor configured to monitor the perishable good parameters and transmit the perishable good parameters to the storage device.

7. A method of organizing perishable goods, the method comprising:
storing, using a storage device, perishable good requirements, loading dock parameters, and perishable good parameters associated with the perishable goods;
analyzing, using a loading dock management system, the perishable good requirements, the loading dock parameters, and the perishable good parameters, the loading dock management system coupled to the storage device, the loading dock management system including:
a perishable good risk module to determine a perishable good risk level for each perishable good in response to the perishable good parameters and the perishable good requirements; and
a loading dock organizational module to determine a loading dock notification in response to the perishable good risk level and the loading dock parameters.

8. The method of claim 7, further comprising:
transmitting, using the loading dock management system, to a user device at least one of the perishable good risk level and the loading dock notification.

9. The method of claim 7, further comprising:
scanning, using a user device, an identification tag of the perishable goods.

10. The method of claim 7, further comprising:
transmitting, using a user device, to the storage device the loading dock parameter in response to the loading dock notification.

11. The method of claim 7, further comprising:
activating, using a user device, an alarm when at least one of the perishable good risk level and the loading dock notification is received from the loading dock management system.

12. The method of claim 9, further comprising:
monitoring, using at least one sensor, the perishable good parameters; and
transmitting the perishable good parameters to the storage device.

13. A computer program product tangibly embodied on a computer readable medium, the computer program product including instructions that, when executed by a processor, cause the processor to perform operations comprising:
storing, using a storage device, perishable good requirements, loading dock parameters, and perishable good parameters associated with the perishable goods;
analyzing, using a loading dock management system, perishable good requirements, loading dock parameters, and perishable good parameters, the loading dock management system coupled to the storage device, the loading dock management system including:
a perishable good risk module to determine a perishable good risk level for each perishable good in response to the perishable good parameters and the perishable good requirements; and
a loading dock organizational module to determine a loading dock notification in response to the perishable good risk level and the loading dock parameters.

14. The computer program of claim 13, wherein the operations further comprise:
transmitting, using the loading dock management system, to a user device at least one of the perishable good risk level and the loading dock notification.

15. The computer program of claim 13, wherein the operations further comprise:
scanning, using a user device, an identification tag of the perishable goods.

16. The computer program of claim 13, wherein the operations further comprise:
transmitting, using a user device, to the storage device the loading dock parameter in response to the loading dock notification.

17. The computer program of claim 13, wherein the operations further comprise:
activating, using a user device, an alarm when at least one of the perishable good risk level and the loading dock notification is received from the loading dock management system.

18. The computer program of claim 13, wherein the operations further comprise:
monitoring, using at least one sensor, the perishable good parameters; and
transmitting the perishable good parameters to the storage device.
